(19) United States
(12) Patent Application Publication
(10) Pub. No.: US 2019/0023434 A1
(43) Pub. Date: Jan. 24, 2019

(54) PAPER-SHEET STORAGE DEVICE

(71) Applicant: MASTERWORK AUTOMODULES TECHNOLOGY CORP., LTD, Taipei City (TW)

(72) Inventors: Wen-Fu YANG, TAIPEI CITY (TW); Wen-Hsien TSAI, TAIPEI CITY (TW)

(21) Appl. No.: 16/034,369

(22) Filed: Jul. 13, 2018

(30) Foreign Application Priority Data
Jul. 19, 2017 (TW) 106124174

(51) Int. Cl. B65B 25/14; B65B 5/06; B65B 51/14; B65B 57/14; G07D 11/00

(52) U.S. Cl. CPC B65B 25/14; B65B 5/067; B65B 51/146; B65B 57/14; G07D 2211/00; G07D 11/0021; G07D 11/0051; G07D 11/0036; G07D 11/0018

(57) ABSTRACT

The disclosure is related to a paper-sheet storage device, which includes a housing, a paper-sheet bag disposing part, a swingable supporting plate, a sealing mechanism, and a first extendible structure. The paper-sheet bag disposing part is disposed in the housing, and is applicable to be removably installed with a paper-sheet bag. The swingable supporting plate is disposed in the housing and above a bottom portion of the paper-sheet bag storage region, and the swingable supporting plate has a supporting surface, a temporary storage region is defined by a space projected upwardly by the supporting surface when the supporting surface faces upwardly. The temporary storage region is applicable to temporarily stack a plurality of paper-sheets received from an inlet, and when the swingable supporting plate swings downwardly, the paper-sheets fall from the temporary storage region and is received by the paper-sheet bag.

### CROSS-REFERENCE TO RELATED APPLICATION

This application claims priority to Taiwan Application Serial Number 106124174, filed Jul. 19, 2017, which is herein incorporated by reference.

### BACKGROUND

### Field of Invention

The present invention relates to a paper-sheet storage device.

### Description of Related Art

In the banking industry, the conveying of banknotes is an imperial part of the daily business. Bills storage devices are becoming more and more universal these day, which successfully reduces working load of staffs in banks. In addition, the bills storage devices enable the banks to receive the bills without the staffs' participants, and thus many formalities and risks are avoided.

As above, it is undoubtedly that the followings are important issues in the industry, which includes: securing the reliability and security of the bills storage devices; ensuring the bills storage devices to operate normally; and reducing participants from real men.

### SUMMARY

One aspect of the present disclosure provides a paper-sheet storage device applicable to a paper-sheet bag machine type, which includes a housing, a paper-sheet bag disposing part, at least one swingable supporting plate, a sealing mechanism, and at least one extendible structure. The paper-sheet bag disposing part is disposed in the housing, the paper-sheet bag disposing part is applicable to be removably installed with a paper-sheet bag, and the paper-sheet bag disposing part and the housing define a paper-sheet bag storage region. The at least one swingable supporting plate is disposed in the housing and above a bottom portion of the paper-sheet bag storage region, and the swingable supporting plate has a supporting surface, a temporary storage region is defined by a space projected upwardly by the supporting surface when the supporting surface faces upwardly, the temporary storage region is applicable to temporarily stack a plurality of paper-sheets received from an inlet, and when the swingable supporting plate swings downwardly, the paper-sheets fall from the temporary storage region and is received by the paper-sheet bag. The sealing mechanism disposed below the paper-sheet bag disposing part, the sealing mechanism is configured to seal the paper-sheet bag; and the at least one first extendible structure is connected in the housing.

Another aspect of the present disclosure provides a paper-sheet storage device, which includes a housing, a paper-sheet bag disposing part, at least one swingable supporting plate, a sealing mechanism, and a bump. The paper-sheet bag disposing part is disposed in the housing. The paper-sheet bag disposing part is applicable to be removably installed with a paper-sheet bag. The paper-sheet bag disposing part and the housing define a paper-sheet bag storage region. The swingable supporting plates are disposed in the housing and above a bottom portion of the paper-sheet bag storage region. Each of the swingable supporting plates has a supporting surface, and a temporary storage region is defined by a space projected upwardly by the supporting surface when the supporting surface faces upwardly. The temporary storage region is applicable to temporarily stack a plurality of paper-sheets received from an inlet (please refer to FIG. 1). When the swingable supporting plates swing downwardly, the paper-sheets fall from the temporary storage region and is received by the paper-sheet bag. The sealing mechanism is disposed below the paper-sheet bag disposing part, and the sealing mechanism is configured to seal the paper-sheet bag. The sealing mechanism includes a pair of abutting parts, and each of the abutting parts has an abutting surfaces. The abutting surfaces face towards each other and are able to approach towards or move away from each other. The bump is disposed on one of the abutting surfaces. When the swingable supporting plate is swung downwardly and the abutting surfaces approach towards each other, the bump abuts against the swingable supporting plate and pushed the swingable supporting plate to swing upwardly.

Yet another aspect of the present disclosure provides a the paper-sheet storage device includes a housing, a paper-sheet bag disposing part, a pair of swingable supporting plates, a sealing mechanism, and a linkage mechanism. The paper-sheet bag disposing part is disposed in the housing. The paper-sheet bag disposing part is applicable to be removably installed with a paper-sheet bag. The paper-sheet bag disposing part and the housing define a paper-sheet bag storage region. The swingable supporting plates are disposed in the housing and above a bottom portion of the paper-sheet bag storage region. Each of the swingable supporting plates has a supporting surface, and a temporary storage region is defined by a space projected upwardly by the supporting surface when the supporting surface faces upwardly. The temporary storage region is applicable to temporarily stack a plurality of paper-sheets received from an inlet (please refer to FIG. 1). When the swingable supporting plates swing downwardly, the paper-sheets fall from the temporary storage region and is received by the paper-sheet bag. The sealing mechanism is disposed below the paper-sheet bag disposing part, and the sealing mechanism is configured to seal the paper-sheet bag. The linkage mechanism connected between the pair of the swingable supporting plates, such that the pair of the swingable supporting plates swing downwardly or upwardly simultaneously.

Yet another aspect of the present disclosure provides a paper-sheet storage device applicable to a paper-sheet bag machine type, which includes a housing, an inlet disposed outside of the housing, an extendible structure, a paper-sheet bag, at least one paper-sheet supporting plate, a sensor, an extension mechanism controller, and a sealing mechanism. The inlet is disposed outside of the housing. The extendible structure is connected in the housing, the extendible structure is extensible along a height direction of the housing. The paper-sheet bag defines a paper-sheet storage space, and the paper-sheet bag has a paper-sheet bag opening facing upwardly. The at least one paper-sheet supporting plate is disposed in the housing and above a bottom portion of the paper-sheet storage space, the paper-sheet supporting plate is able to move with the extension of the extendible structure, the paper-sheet supporting plate has a supporting surface. The sensor is disposed above the paper-sheet supporting plate, the sensor is configured to measure a distance between itself and a plurality of paper-sheets on the paper-sheet supporting plates. The extension mechanism controller is electrically connected to the sensor and the extendible structure, the extension mechanism controller is configured to control the extension and contraction of the extendible structure according to the distance measure by the sensor. The sealing mechanism is disposed in the housing and adjacent to the paper-sheet bag opening, the sealing mechanism is configured to seal the paper-sheet bag. When the paper-sheet supporting plate is in a first state, a temporary storage region is defined by a space projected upwardly by the supporting surface, the temporary storage region is applicable to temporarily stack the paper-sheets received from the inlet, when the paper-sheet supporting plate is in a second state, the paper-sheet supporting plate forms an opening therebetween to let the paper-sheets fall from the opening and passing through the paper-sheet bag opening and fall into the paper-sheet bag. When the distance measured by the sensor is smaller than a first predetermined quantity, the extendible structure extends downwardly, and when the distance measured by the sensor is greater than a second predetermined quantity, the sealing mechanism seal the paper-sheet bag, the second predetermined quantity is greater than the first predetermined quantity.

Yet another aspect of the present disclosure provides a paper-sheet storage device applicable to a paper-sheet bag machine type, which includes a cabinet, an inlet, at least one scissor-like extendible structure, a paper-sheet bag, at least one paper-sheet supporting plate, a film structure, and a sealing mechanism. The inlet is disposed outside of the cabinet. The at least one scissor-like extendible structure is connected in the cabinet, the scissor-like extendible structure is extendible along a height direction of the cabinet. The paper-sheet bag is disposed in the cabinet, and the paper-sheet bag defines a paper-sheet storage space, and has a paper-sheet bag opening facing upwardly, the paper-sheet bag opening is applicable to receive a plurality of paper-sheets sent from the inlet. The at least one paper-sheet supporting plate is disposed in the cabinet and above a bottom portion of the paper-sheet storage space, and the paper-sheet supporting plate is connected to the scissor-like extendible structure and is able to move with the extension of the scissor-like extendible structure, an end of the paper-sheet supporting plate most distal to the scissor-like extendible structure is defined as a distal end. An end of the film structure is connected to the cabinet, the other end is connected to a bottom end of the scissor-like extendible structure, and the film structure is closer to the scissor-like extendible structure than the distal end of the paper-sheet supporting plate. The sealing mechanism is disposed in the cabinet and adjacent to the paper-sheet bag opening, the sealing mechanism is configured to seal the paper-sheet bag. When the paper-sheet supporting plate is in a first state, a temporary storage region is defined by a space projected upwardly by a supporting surface of the paper-sheet supporting plate, the temporary storage region is applicable to temporarily stack the paper-sheets received from the inlet, when the paper-sheet supporting plate is in a second state, the paper-sheet supporting plate forms an opening therebetween to let the paper-sheets fall from the opening and pass through the paper-sheet bag opening and fall into the paper-sheet bag.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a cross-sectional view of a paper-sheet storage device according to an embodiment of the present disclosure;

FIG. 2 illustrates a schematic perspective view of a lower module according to an embodiment of the present disclosure;

FIG. 3 illustrates a partial cross-sectional view along line A in FIG. 2;

FIG. 4 illustrates a lower perspective view of the swingable supporting plate shown in FIG. 3;

FIG. 5 illustrates a cross-sectional view along line B in FIG. 2;

FIG. 6 illustrates a cross-sectional perspective view along line B in FIG. 2;

FIG. 7 illustrates a partial enlarging view of a portion C shown in FIG. 5;

FIG. 8 illustrates a state that paper-sheets are stacked in a temporary storage region at the beginning;

FIG.9 illustrates a state that the paper-sheets in the temporary storage region are accumulated and first extendible structures extend downwardly;

FIG. 10 illustrates a cross-sectional view of the lower module shown in FIG. 1 during operation, in which that the second extendible structure extends towards and abuts against the paper-sheets;

FIG. 11 illustrates a cross-sectional view of the lower module shown in FIG. 1 during operation, in which that the paper-sheets are falling into the paper-sheet bag;

FIG. 12 illustrates the lower module shown in FIG. 1 during operation, in which that after the paper-sheets fall into the paper-sheet bag, the first extendible structures and the second extendible structure are all pull back in a contraction state;

FIG. 13 illustrates a stereo perspective view of a rolling shaft according to another embodiment of the present disclosure;

FIG. 14 illustrates a front view of the lower conveying channel shown in FIG. 1;

FIG. 15 illustrates a cross-sectional view of a paper-sheet storage device according to another embodiment of the present disclosure;

FIG. 16 illustrates an upper perspective view of the swingable supporting plates shown in FIG. 15;

FIG. 17 illustrates a cross-sectional view of the paper-sheet storage device shown in FIG. 15 when the swingable supporting plates are swung downwardly;

FIG. 18 illustrates a cross-sectional view of a paper-sheet storage device according to yet another embodiment of the present disclosure;

FIG. 19 illustrates a state that the first extendible structure extends downwardly, such that the first linkage and the second linkage leave the connecting member.

FIG. 20 illustrates a front view of the swingable supporting plates and the linkage mechanism when the swingable supporting plates have been released by the power lock.

FIG. 21 illustrates a front view of the swingable supporting plates and the linkage mechanism in another state; and

FIG. 22 illustrates a front view of the swingable supporting plates and the linkage mechanism in the state shown in FIG. 18.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

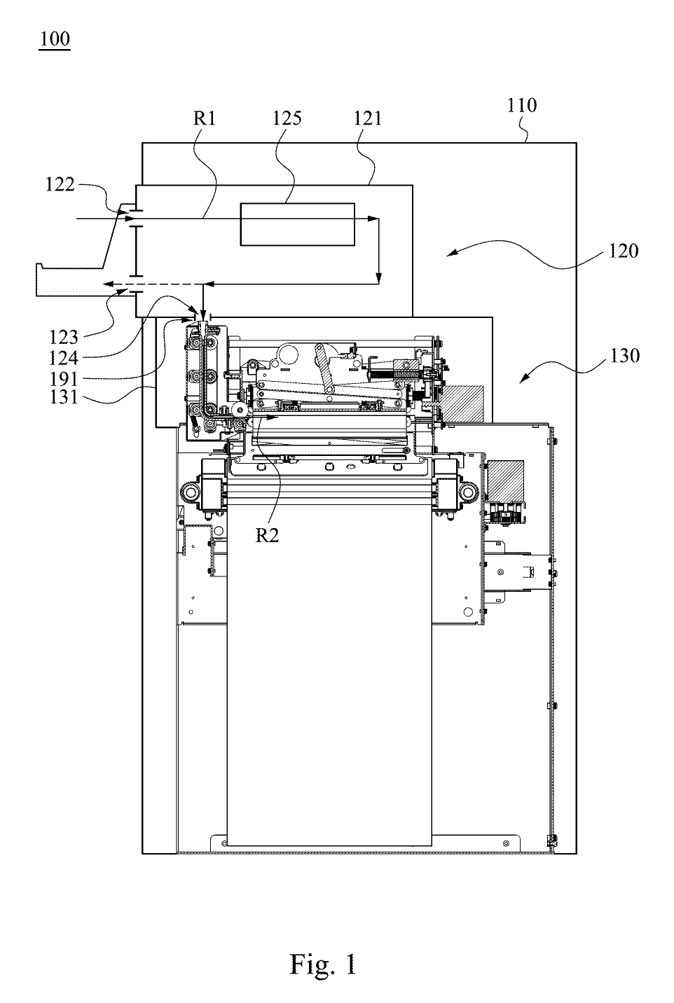

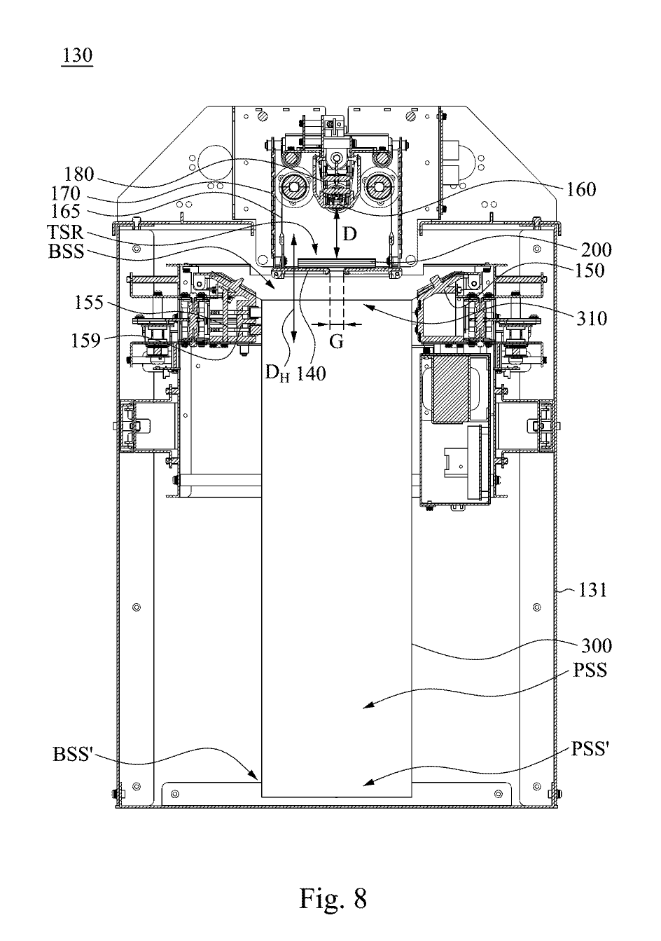

Please refer to FIG. 1, which illustrates a cross-sectional view of a paper-sheet storage device 100 according to an embodiment of the present disclosure. In the present embodiment, as shown in FIG. 1, a paper-sheet storage device 100 includes a housing 110, an upper module 120, and a lower module 130. The upper module 120 and the lower module 130 are both at least partially located in the housing 110, and the upper module 120 is substantially located above the lower module 130. The upper module 120 includes a casing 121 and a discrimination unit 125. The casing 121 has an inlet 122, an outlet 123, and a conveyance port 124. The inlet 122 is disposed outside of the housing 110, and is configured to permit the paper-sheets 200 (which are shown in FIG. 8 to FIG. 13) to be sent into the casing 121 in order. The outlet 123 and the conveyance port 124 are configured to permit the paper-sheets 200 to leave the casing 121 in order. In practical application, the paper-sheets 200 may be bills, checks, or any other paper-sheet like items, the present disclosure is not limited thereto. The discrimination unit 125 is disposed in the casing 121, the discrimination unit 125 is configured to discriminate at least one feature of the paper-sheets 200.

It is worth mentioning that unallowed paper-sheet could be counterfeit money, abnormal cash (such as cash with tape attached thereon), contaminated cash may fail the discrimination. And it is worth mentioning that allowed paper-sheets could be normal bills, authenticated bills, etc.

After the paper sheets pass through the discrimination unit 125, the conveyance route R1 is configured to permit allowed paper-sheets, to be sent to the conveyance port 124, and to permit the unallowed paper-sheets to be sent to the outlet 123 and leave the casing 121. The lower module 130 has a first end opening 191, the conveyance port 124 of the upper module 120 is located correspondingly to the first end opening 191 of the lower module 130. In other words, the paper-sheets 200 are conveyed from the inlet 122 to the discrimination unit 125 along a conveyance route R1 in the upper module 120, and then the allowed paper-sheets 200 will be further conveyed to the conveyance port 124 along the conveyance route R1 in the upper module 120, and then the paper-sheets 200 pass through the conveyance port 124 and the first end opening 191 of the lower module 130 and enter the lower module 130, and then the paper-sheets are conveyed along a conveying route R2 in the lower module 130.

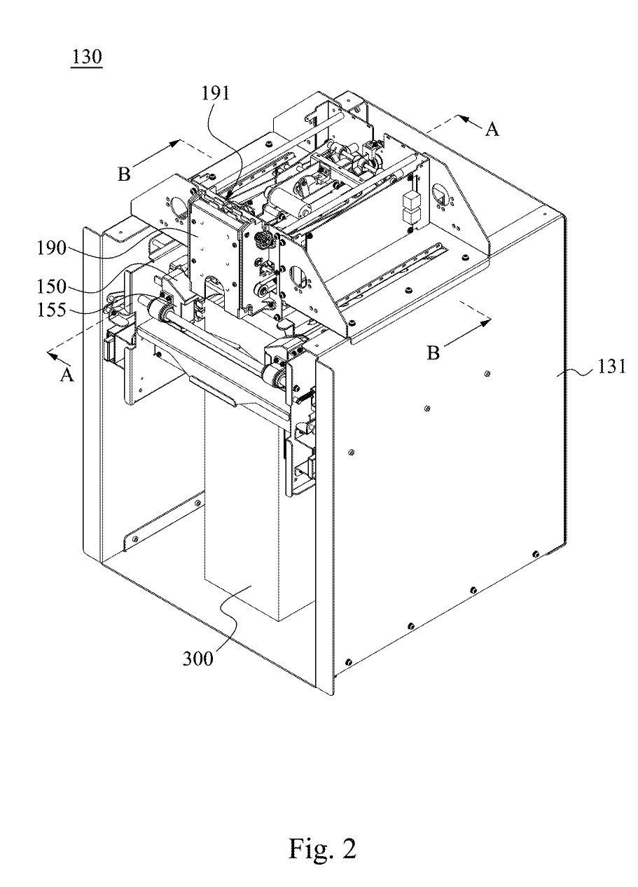

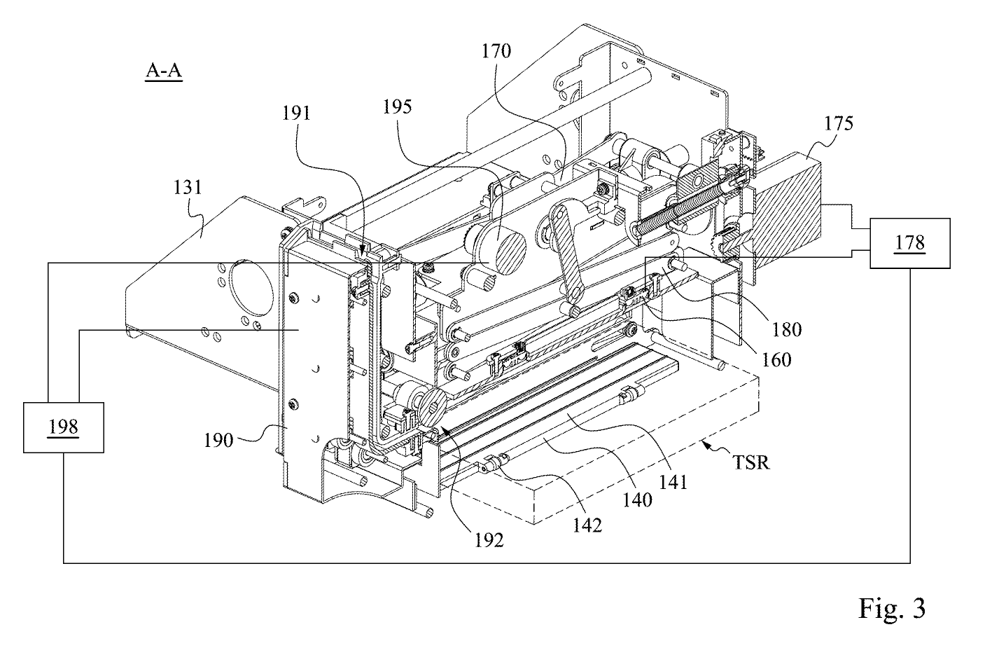

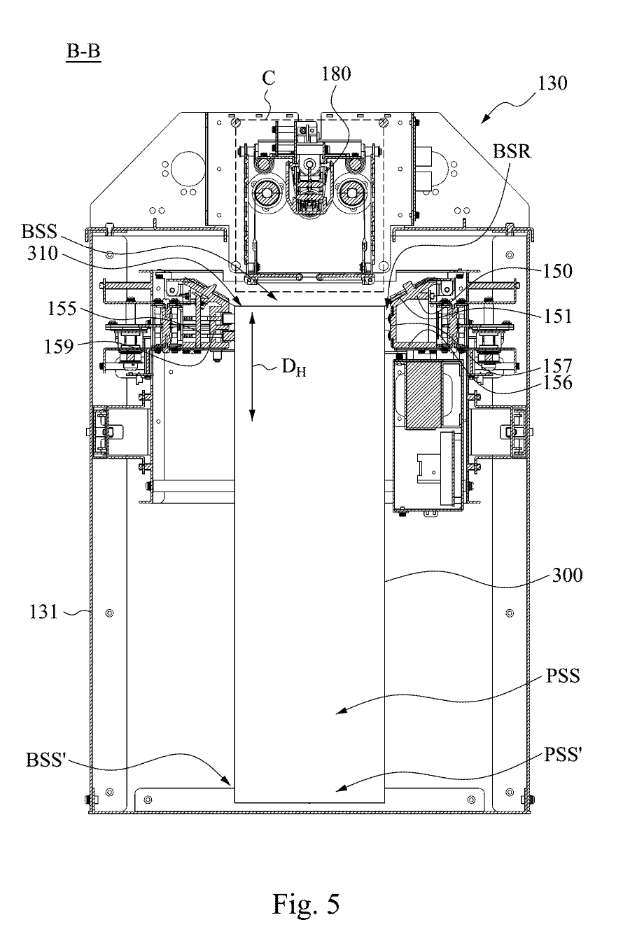

Please refer to FIG. 2 to FIG. 3. FIG. 2 illustrates a schematic perspective view of the lower module 130 according to an embodiment of the present disclosure. FIG. 3 illustrates a partial cross-sectional view along line A in FIG. 2. In the present embodiment, as shown in FIG. 2 and FIG. 3, the lower module 130 of the paper-sheet storage device 100 includes a cabinet 131, at least one swingable supporting plate 140, a paper-sheet bag disposing part 150, and a sealing mechanism 155. In general, cabinet 131 may be a so-called strongbox, the swingable supporting plate 140 is disposed in the cabinet 131, and the swingable supporting plate 140 has a supporting surface 141, when the supporting surface 141 faces upwardly, a temporary storage region TSR is defined by a space upwardly projected by the supporting surface 141, the TSR is applicable to temporarily stack the paper-sheets 200 received from the inlet 122. The paper-sheet bag disposing part 150 is disposed in the cabinet 131, and is applicable to be removably installed with a paper-sheet bag 300, the paper-sheet bag 300 defines a paper-sheet storage space PSS (which is shown in FIGS. 5-6 and FIGS. 8-12), the paper-sheet bag disposing part 150 and the cabinet 131 define a paper-sheet bag storage space BSS (which is shown in FIGS. 5-6 and FIGS. 8-12) to accommodate paper-sheet bag 300. Furthermore, the swingable supporting plate 140 is disposed over a bottom portion PSS′ of the paper-sheet storage space PSS (the bottom portion PSS′ is shown in FIGS. 5-6 and FIGS. 8-12). In other words, the swingable supporting plate 140 is disposed above a bottom portion BSS′ of the paper-sheet bag storage space BSS (the bottom portion BSS′ is shown in FIGS. 5-6 and FIGS. 8-12), and the paper-sheet bag 300 has a paper-sheet bag opening 310 (which is shown in FIGS. 5-6 and FIGS. 8-12) facing upwardly, the paper-sheet storage space PSS is applicable to receive the paper-sheets 200 sent from the inlet 122 to the swingable supporting plate 140 and let the paper-sheets 200 to pass through the paper-sheet bag opening 310. When the swingable supporting plate 140 swings downwardly, the paper-sheet bag 300 receives the paper-sheets 200 fallen from the temporary storage region TSR. The sealing mechanism 155 is disposed in the cabinet 131 and below the paper-sheet bag disposing part 150, and is adjacent to the paper-sheet bag opening 310, and the sealing mechanism 155 is configured to seal the paper-sheet bag 300.

In other words, when the swingable supporting plate 140 swings downwardly, the paper-sheets 200 stack in the temporary storage region TSR lose support of the supporting surface 141, and thus the paper-sheets 200 fall into the paper-sheet bag 300. As such, by the swinging of the swingable supporting plate 140 to make the swingable supporting plates 140 form an opening therebetween and result in the paper-sheets 200 to fall into the paper-sheet bag 300, arbitrary number of the paper-sheets 200 may be appropriate, and without limitation on the quantity of the paper-sheets 200, the paper-sheet storage device 100 may operate with more efficiency.

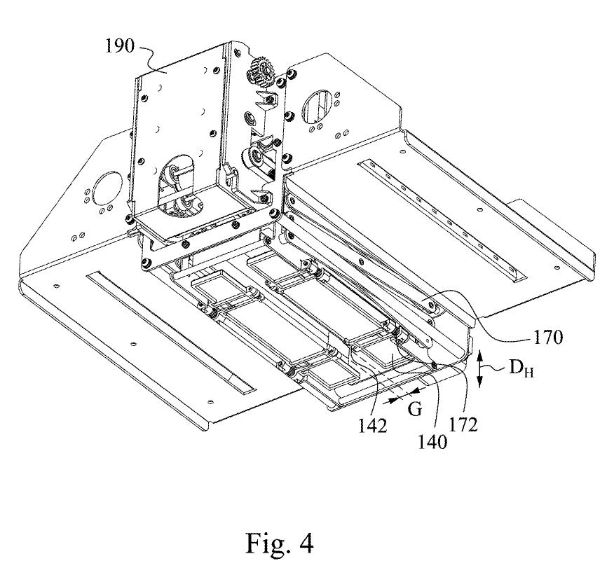

Please refer to FIG. 4, which illustrates a lower perspective view of the swingable supporting plate 140 shown in FIG. 3. As shown in FIG. 4, the lower module 130 of paper-sheet storage device 100 further includes at least one first extendible structure 170 and at least one first torsion spring 172. The first extendible structure 170 is connected in the cabinet 131, and is extendible in a height direction Dₕ of the cabinet 131. The first torsion spring 172 is connected to the first extendible structure 170 and the swingable supporting plate 140, such that the swingable supporting plate 140 is linked with the first extendible structure 170, and the swingable supporting plate 140 may move with the extension or contraction of the first extendible structure 170.

In practical application, there is a pair of the swingable supporting plates 140, a pair of the first extendible structures 170, and a pair of the first torsion springs 172. As shown in FIG. 4, the swingable supporting plates 140 face towards each other, and are located between the first torsion springs 172, and the swingable supporting plates 140 are separated with a gap G. When the swingable supporting plates 140 are in a first state, the swingable supporting plates 140 are substantially horizontally disposed, and the temporary storage region TSR is defined by a space upwardly projected by the supporting surfaces 141 of the swingable supporting plates 140, and the swingable supporting plates 140 are applicable to permit the paper-sheets 200 to temporarily stacked on the supporting surfaces 141. When the swingable supporting plates 140 are in a second state, the swingable supporting plates 140 may form an opening therebetween(in other words, enlarge the gap G) to permit the paper-sheets 200 to fall from the opening and pass through the paper-sheet bag opening 310 and fall into the paper-sheet bag 300.

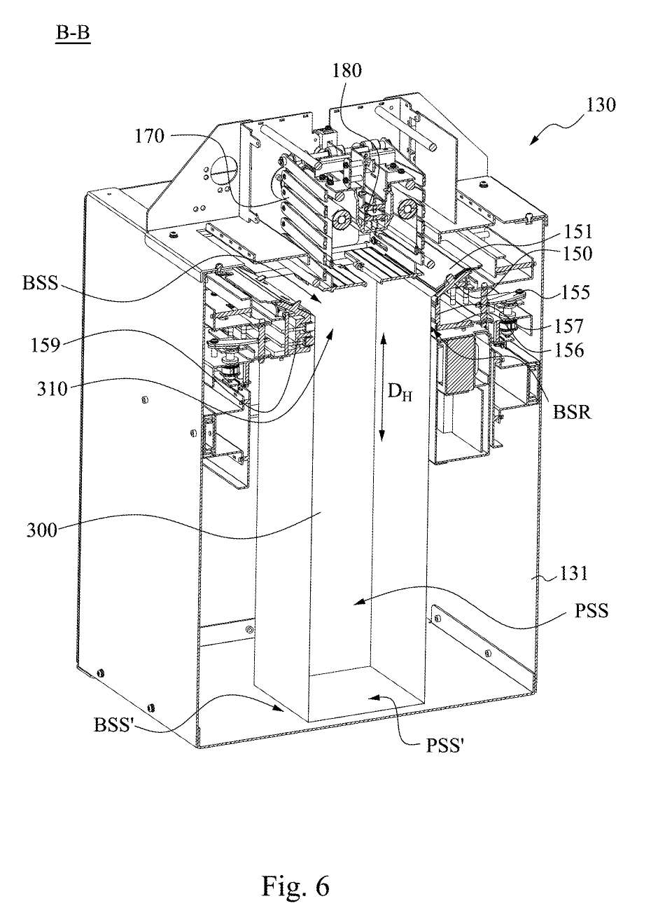

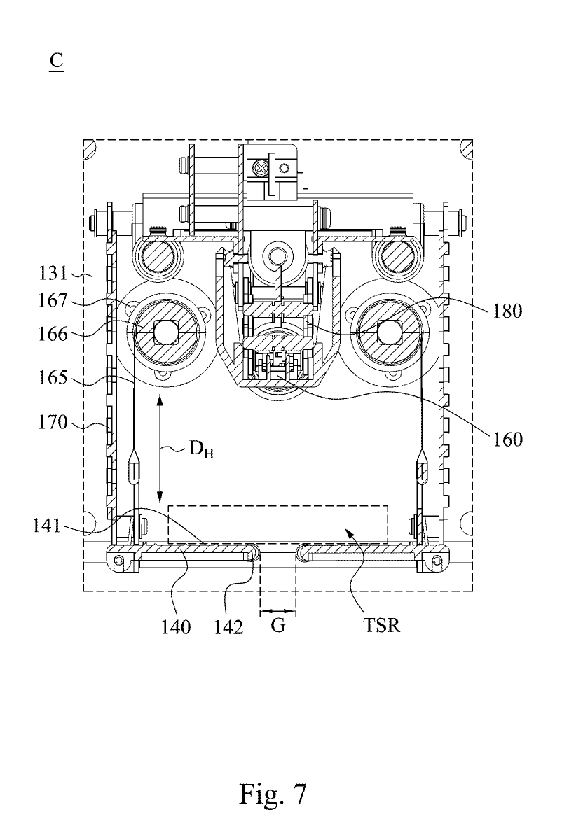

Please refer to FIG. 5 to FIG. 7. FIG. 5 illustrates a cross-sectional view along line B in FIG. 2. FIG. 6 illustrates a cross-sectional perspective view along line B in FIG. 2. FIG. 7 illustrates a partial enlarging view of a portion C shown in FIG. 5. As shown in FIGS. 3, and 5-7, the lower module 130 of the paper-sheet storage device 100 may further include a second extendible structure 180. The second extendible structure 180 is connected in the cabinet 131, and is at least partially located between the first extendible structures 170. It should be noted that, a bottom portion of the second extendible structure 180 is higher than the swingable supporting plate 140.

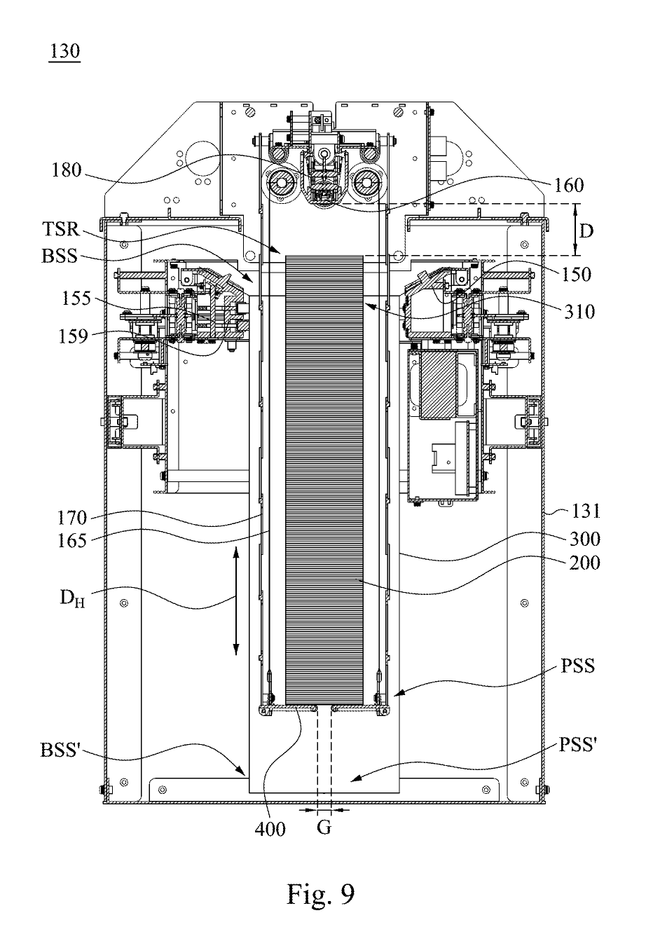

As shown in FIGS. 3 and 7, the lower module 130 of the paper-sheet storage device 100 further includes a sensor 160. The sensor 160 is disposed at a bottom portion of the second extendible structure 180 and above the swingable supporting plates 140, the sensor 160 is configured to measure a distance D between itself and the paper-sheets 200 located in the temporary storage region TSR (distance D is shown in FIGS. 8 and 9), so as to ensure the temporary storage region TSR provides sufficient space for paper-sheets 200 to be stacked in.

In particular, as shown in FIG. 3, the lower module 130 of the paper-sheet storage device 100 further includes a second power source 175 and a second extension mechanism controller 178. The second power source 175 is connected to the first extendible structures 170, and the second extension mechanism controller 178 is electrically connected to the second power source 175 and the sensor 160. Please refer to FIGS. 8-9. FIGS. 8-9 both illustrate a cross-sectional view of the lower module 130 during operation, in which that FIG. 8 illustrates a state that the paper-sheets 200 are stacked in the temporary storage region TSR at the beginning, and FIG. 9 illustrates a state that the paper-sheets 200 in the temporary storage region TSR are accumulated and the first extendible structures 170 extend downwardly. In practical application, when the amount of the paper-sheets 200 is gradually increased in the temporary storage region TSR, such that the distance D measured by the sensor 160 is smaller than a first predetermined quantity, the second extension mechanism controller 178 would activate the second power source 175 so as to drive the first extendible structure 170 to extend downwardly, so as to ensure the temporary storage region TSR provides sufficient space for the paper-sheets 200 to be stacked in. At the same time, the swingable supporting plates 140 are in the first state that is applicable to support the paper-sheets 200. In other words, the swingable supporting plates 140 are disposed substantially horizontally.

It should be noted that, as shown in FIG. 9, when the first extendible structures 170 extend downwardly into the paper-sheet bag 300, the first extendible structures 170 are at an inner side of the paper-sheet storage space PSS with respect to the paper-sheet bag 300. In other words, the first extendible structures 170 further restrict the paper-sheets 200 in a width direction, such that the paper-sheets 200 may be stacked more precisely.

Further, by the gradually extension of the first extendible structure 170, the height of the temporary storage region TSR may be restricted in a certain range, and the restricted height of the temporary storage region TSR may effectively prevent the paper-sheets 200 from rolling over in an oversized temporary storage region TSR, and thus making the paper-sheets 200 to be stacked neatly.

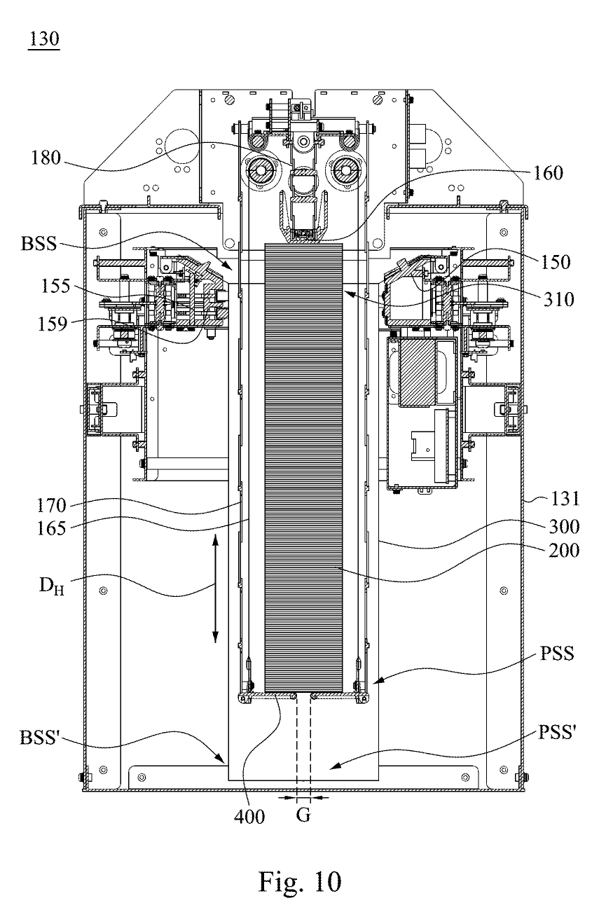

Furthermore, as shown in FIG. 3, the lower module 130 of the paper-sheet storage device 100 further includes an lower conveying channel 190, a first power source 195, and a first extension mechanism controller 198. The lower conveying channel 190 is connected to the cabinet 131, the first end opening 191 of the lower module 130 is located at the lower conveying channel 190, the lower conveying channel 190 further includes a second end opening 192, the first end opening 191 and the second end opening 192 face towards each other, and the second end opening 192 is located correspondingly to the temporary storage region TSR. In particular, the lower conveying channel 190 is configured to convey the paper-sheets 200 from the first end opening 191 to the temporary storage region TSR through the second end opening 192. In addition, the first power source 195 is mechanically connected to the second extendible structure 180, the first extension mechanism controller 198 is electrically connected to the lower conveying channel 190 and the first power source 195. Please refer to FIG. 10, which illustrates a cross-sectional view of the lower module 130 shown in FIG. 1 during operation, in which that the second extendible structure 180 extends towards and abuts against the paper-sheets 200. When a predetermined quantity of the paper-sheets 200 are conveyed by the lower conveying channel 190 to the temporary storage region TSR, the first extension mechanism controller 198 activates the first power source 195 so as to drive the second extendible structure 180 to extend towards and abut against the paper-sheets 200. For example, the predetermined quantity of the paper-sheets 200 may be 1500, 2000, 2500, or any other suitable number, the present disclosure is not limited thereto.

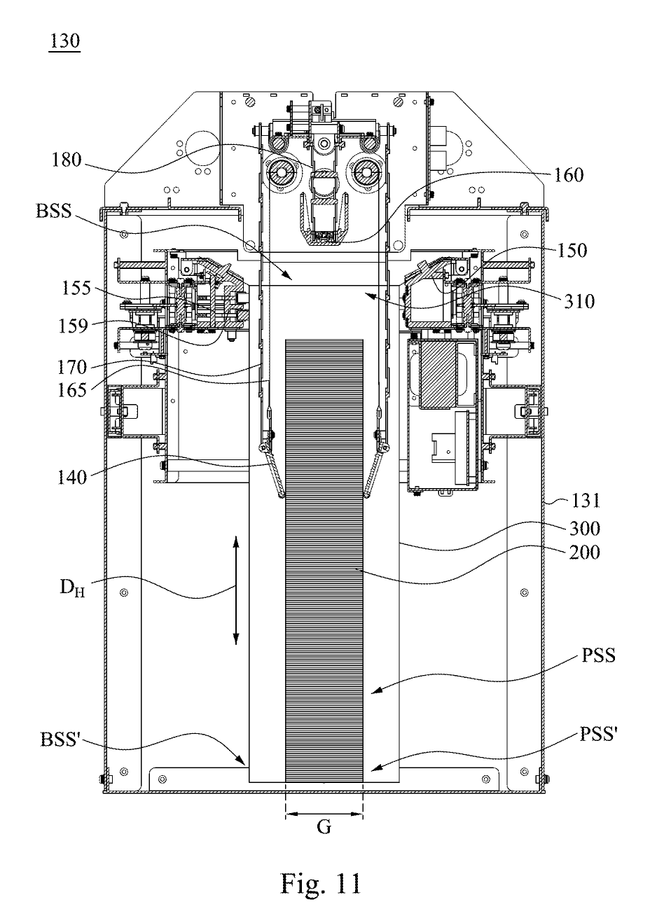

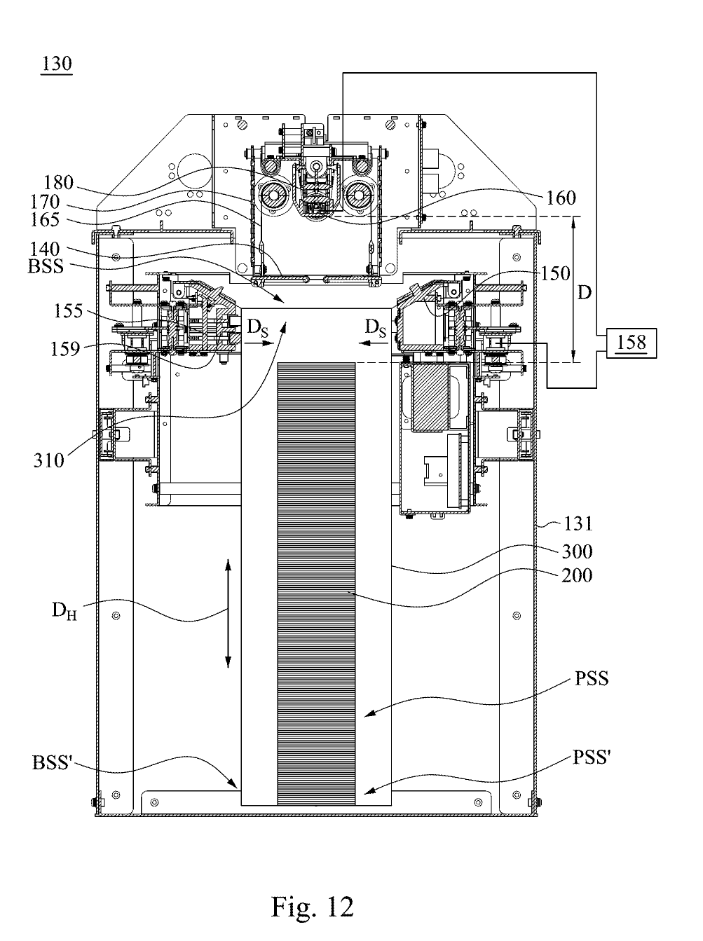

Please refer to FIGS. 11-12. FIG. 11 illustrates a cross-sectional view of the lower module 130 shown in FIG. 1 during operation, in which that the paper-sheets 200 are falling into the paper-sheet bag 300. FIG. 12 illustrates the lower module 130 shown in FIG. 1 during operation, in which that after the paper-sheets 200 fall into the paper-sheet bag 300, the first extendible structures 170 and the second extendible structure 180 are all pull back in a contraction state. As above, the second extension mechanism controller 178 is electrically connected to the second power source 175. In addition, the second extension mechanism controller 178 is also electrically connected to the first extension mechanism controller 198 (please refer to FIG. 3). When the first extension mechanism controller 198 drive the second extendible structure 180 to abut against the paper-sheets 200 stored in the temporary storage region TSR, the second extension mechanism controller 178 activates the second power source 175 to drive the first extendible structures 170 to contract upwardly. When the first extendible structures 170 contract upwardly, the paper-sheets 200 are abutted against by the second extendible structure 180, the supporting forces provided by the first torsion springs 172 connected to the swingable supporting plates 140 are thus annihilated by the aforementioned abutting force, so as to drive the swingable supporting plates 140 to swing downwardly and get into the aforementioned second state. In other words, the gap G between the swingable supporting plates 140 is enlarged to let the stacked paper-sheets 200 to fall into the paper-sheet bag 300. When all of the paper-sheets 200 fall into paper-sheet bag 300, and the swingable supporting plates 140 are not contacting with the paper-sheets 200 anymore, the abutting force applied on the swingable supporting plates 140 by the paper-sheets 200 is thus non-existent. As a result, the first torsion springs 172 make the swingable supporting plates 140 restore in a horizontal state. In addition, when the first extendible structures 170 and the second extendible structure 180 are all in a contraction state, the first extendible structures 170 and the second extendible structure 180 are all located above the sealing mechanism 155. As such, when the sealing mechanism 155 seals the paper-sheet bag 300, the sealing mechanism 155 would not be interfered by the first extendible structure 170 or the second extendible structure 180, which is advantageous for the sealing mechanism 155 to seal the paper-sheet bag 300 at the paper-sheet bag opening 310.

Furthermore, the first extendible structures 170 may be scissor-like extendible structures, and the lower module 130 of the paper-sheet storage device 100 further includes a film structure 165. As shown in FIGS. 7-12, an end of the film structure 165 is connected to the cabinet 131. The other end of the film structure 165 is connected to a bottom end of the scissor-like extendible structures, both of the swingable supporting plates 140 have a distal end 142 which is farthest to the scissor-like extendible structures (the distal ends 142 are shown in FIGS. 3-4 and 7), the aforementioned gap G is located between the distal ends 142, and the film structure 165 may be closer to the scissor-like extendible structure than the distal ends 142 of the swingable supporting plates 140. In other words, the film structure 165 is at least partially located between the scissor-like extendible structures and within the temporary storage region TSR. As such, by the separation of the film structure 165, it is effectively prevented the paper-sheets 200 located in the temporary storage region TSR from stuck in the scissor-like extendible structures. In addition, in the embodiment implemented with scissor-like extendible structures, the second power source 175 connected to the first extendible structure 170 may be utilized with mechanical type mechanism, hydraulic type mechanism, or any other suitable type mechanism, the present disclosure is not limited thereto.

On the other hand, the present embodiment for example, the second extendible structure 180 may also be a scissor-like extendible structure, but the present disclosure is not limited thereto.

In addition, in the present embodiment, the lower module 130 of paper-sheet storage device 100 further includes a rolling shaft 166 and at least one second torsion spring 167. As shown in FIG. 7, the rolling shaft 166 is pivoted to the cabinet 131, in other words, the rolling shaft 166 may rotate with the cabinet 131, and the film structure 165 is connected to the rolling shaft 166. When the rolling shaft 166 is rotated, the film structure 165 wrapping around the rolling shaft 166 may be pulled out, or be wrapped on the rolling shaft 166 otherwise. The second torsion spring 167 is connected to the rolling shaft 166 and the cabinet 131. In other words, when the extendible structure extends downwardly, the film structure 165 wrapping around the rolling shaft 166 may be pulled out, and thus the second torsion spring 167 is stored with an elastic potential force, which holds a pulling force on the film structure 165. When the extendible structure is contracted upwardly, the second torsion spring 167 releases the stored elastic potential force, so as to make the film structure 165 rotate correspondingly and wrap around the rolling shaft 166. As such, the film structure 165 may be pulled tight anytime, and be located between the temporary storage region TSR and the paper-sheets 200, so as to prevent the paper-sheets 200 from stuck in the scissor-like extendible structures.

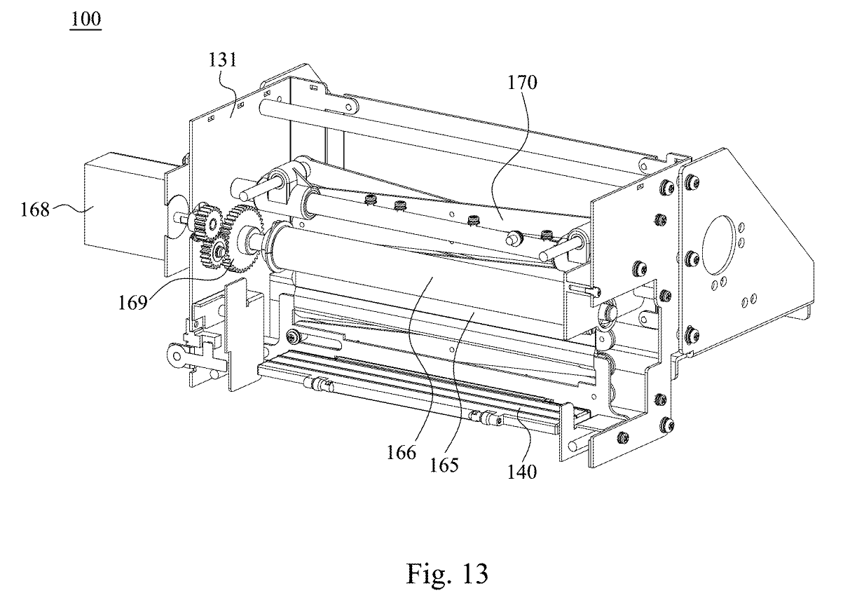

Please refer to FIG. 13, which illustrates a stereo perspective view of the rolling shaft 166 according to another embodiment of the present disclosure. In the present embodiment, the paper-sheet storage device 100 further includes a third power source 168 and a gear set 169. As shown in FIG. 13, the rolling shaft 166 is connected to the cabinet 131, and the film structure 165 is connected with the rolling shaft 166. The gear set 169 is mechanically connected to the rolling shaft 166 and the third power source 168. The third power source 168 provides power, so as to rotate the rolling shaft 166 via the gear set 169. As such, the operation of the film structure 165 corresponding to the scissor-like extendible structures may be more flexible.

On the other hand, as shown in FIGS. 5 and 6, the paper-sheet bag disposing part 150 includes at least a pair of installing surfaces 151, which are configured to install the paper-sheet bag 300. The sealing mechanism 155 includes a pair of abutting parts 156, a paper-sheet bag storage region BSR is defined between the abutting parts 156. The paper-sheet bag 300 is at least partially located in the paper-sheet bag storage region BSR. The abutting parts 156 have abutting surfaces 157, which are facing towards each other and are capable of moving towards or away from each other, and each of the abutting surfaces 157 are adjacent to a corresponding one of the installing surfaces 151. Each of the installing surface 151 is slanting towards a corresponding one of the abutting surfaces 157. As shown in FIG. 12, the lower module 130 of the paper-sheet storage device 100 further includes a sealing controller 158. The sealing controller 158 is electrically connected to the sealing mechanism 155, and is configured to activate the sealing mechanism 155 so as to make the abutting surfaces 157 move towards each other. In the present embodiment, the sealing mechanism 155 further includes a heater 159 (which is shown in FIGS. 8-12). In particular, when the abutting surfaces 157 move towards each other, the heater 159 of the sealing mechanism 155 heats up. By the heating of the heater 159 and the pressing of the abutting surfaces 157, the paper-sheet bag opening 310 of the paper-sheet bag 300 is sealed.

In practical application, when the abutting surfaces 157 move towards each other, in order to prevent the stacking of the paper-sheets 200 being abnormally interfered (which would result in the paper-sheets 200 to exist in a region between the abutting surfaces 157), the sensor 160 is further electrically connected to the sealing controller 158, as shown in FIG. 12. If the distance D measured by the sensor 160 is greater than a second predetermined quantity, it is determined that the stacking of the paper-sheets 200 are not abnormally interfered and no paper-sheets 200 are located between the abutting surfaces 157, the sealing controller 158 activates the sealing mechanism 155, so as to make the abutting surfaces 157 to move towards each other along a sealing direction Dₛ shown in FIG. 12, so as to seal the paper-sheet bag 300. For example, in the present embodiment, the second predetermined quantity may be a vertical distance between the location of the sensor 160 and a bottom point of the abutting surfaces 157. As a result, the second predetermined quantity is greater than the first predetermined quantity.

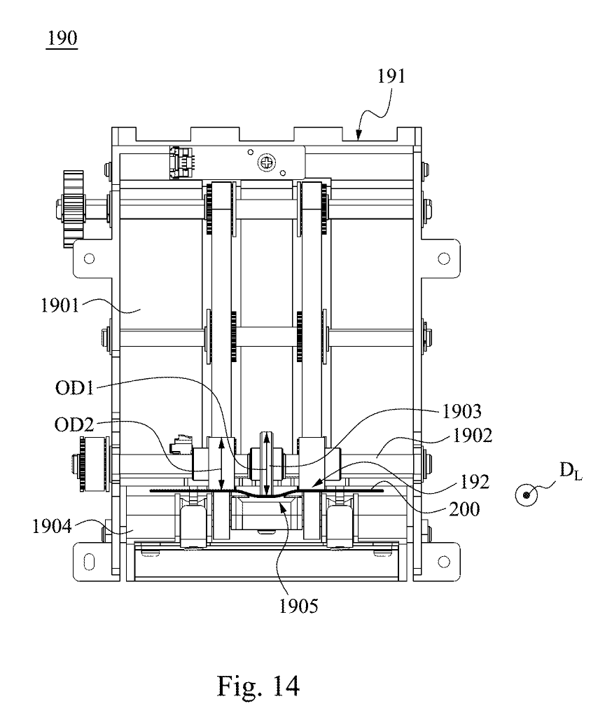

Please refer to FIG. 14, which illustrates a front view of the lower conveying channel 190 shown in FIG. 1. In the present embodiment, as shown in FIG. 14, the lower conveying channel 190 further includes a main body 1901, a rotating shaft 1902, and a pressing wheel 1903. The main body 1901 has a guiding plate 1904, which has a recessing portion 1905. The rotating shaft 1902 is pivoted to the main body 1901, and the second end opening 192 is located between the rotating shaft 1902 and the guiding plate 1904. The pressing wheel 1903 is disposed on the rotating shaft 1902, an outside diameter OD1 of the pressing wheel 1903 is greater than the outside diameter OD2 of the rotating shaft 1902, and the location of the pressing wheel 1903 corresponds to the recessing portion 1905. The lower conveying channel 190 permits the paper-sheets 200 to be sent out from the second end opening 192 along a vertical direction D_{L} of the paper-sheets 200. The pressing wheel 1903 abuts against the paper-sheets 200 and makes the paper-sheets 200 at least partially deform towards the recessing portion 1905. As such, by the deformation of the paper-sheets 200, the rigidity of the paper-sheets 200 along the vertical direction D_{L} may be enhanced, which is beneficial for the paper-sheets 200 to be stacked neatly in the temporary storage region TSR. In FIG. 14, the vertical direction D_{L} is a direction perpendicular to the drawing.

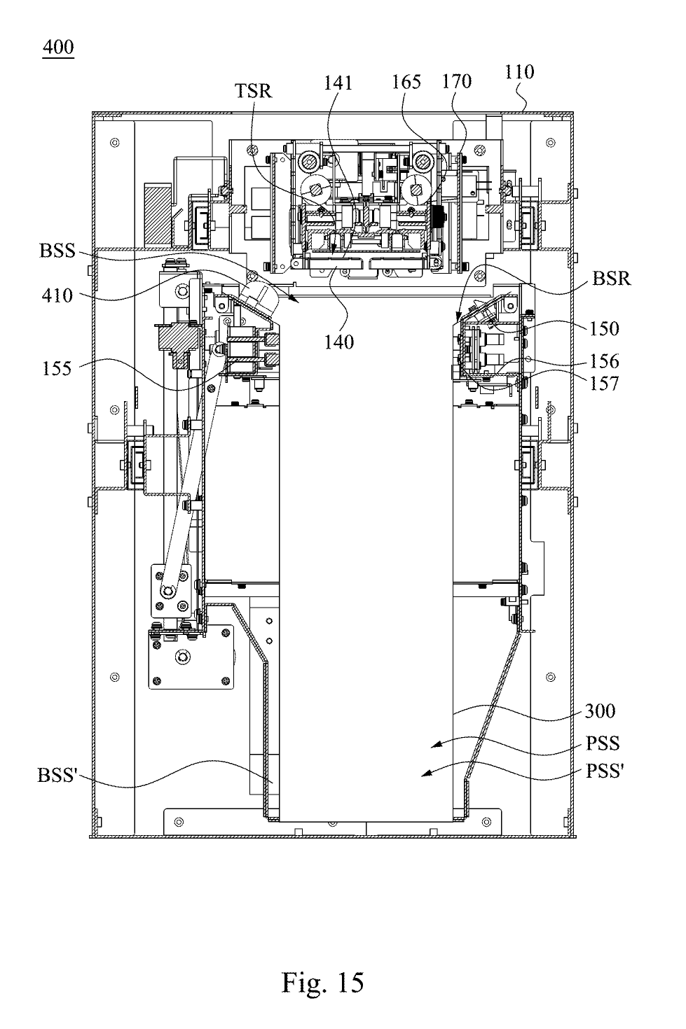

Please refer to FIG. 15, which illustrates a cross-sectional view of a paper-sheet storage device 400 according to another embodiment of the present disclosure. As shown in FIG. 15, the paper-sheet storage device 400 includes a housing 110, a paper-sheet bag disposing part 150, two swingable supporting plates 140, a sealing mechanism 155, at least one first extendible structure 170, and a bump 410. The paper-sheet bag disposing part 150 is disposed in the housing 110. The paper-sheet bag disposing part 150 is applicable to be removably installed with a paper-sheet bag 300. The paper-sheet bag disposing part 150 and the housing 110 define a paper-sheet bag storage region BSR. The swingable supporting plates 140 are disposed in the housing 110 and above a bottom portion of the paper-sheet bag storage region BSR. Each of the swingable supporting plates 140 has a supporting surface 141, and a temporary storage region TSR is defined by a space projected upwardly by the supporting surfaces 141 when the supporting surfaces 141 face upwardly. The temporary storage region TSR is applicable to temporarily stack a plurality of paper-sheets (not shown) received from an inlet 122 (please refer to FIG. 1). When the swingable supporting plates 140 swing downwardly, the paper-sheets fall from the temporary storage region TSR and then the paper-sheets are received by the paper-sheet bag 300. The sealing mechanism 155 is disposed below the paper-sheet bag disposing part 150, and the sealing mechanism 155 is configured to seal the paper-sheet bag 300. The sealing mechanism 155 includes a pair of abutting parts 156, and each of the abutting parts 156 has an abutting surface 157. The abutting surfaces 157 face towards each other and are able to approach towards or move away from each other. The bump 410 is disposed above one of the abutting surfaces 157. When the swingable supporting plates 140 are swung downwardly and the abutting surfaces 157 approach towards each other, the bump 410 abuts against one of the swingable supporting plates 140 and pushed the swingable supporting plates 140 to swing upwardly.

As shown in FIG. 15, most of the elements are similar to those drawn in FIG. 5. However, the moving mechanism of the swingable supporting plates 140 in the paper-sheet storage device 400 is different from that in the paper-sheet storage device 100.

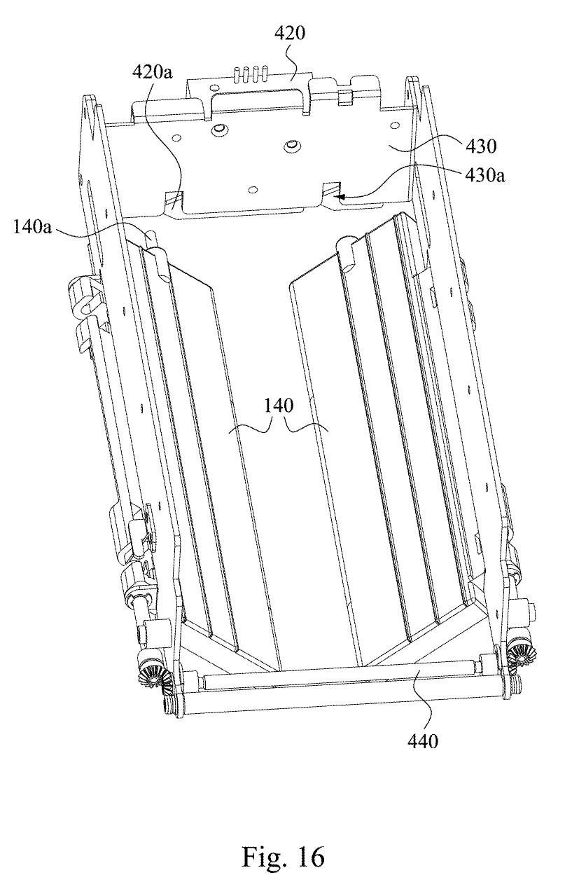

Please refer to FIG. 16, which illustrates an upper perspective view of the swingable supporting plates 140 shown in FIG. 15. As shown in FIG. 16, the paper-sheet storage device 400 further includes a power lock 420, which is disposed above the swingable supporting plates 140. In particular, there is a connecting plate 430 connected between the swingable supporting plates 140, and the power lock 420 is disposed on the connecting plate 430.

As shown in FIG. 16, the power lock 420 includes two gate structures 420a, and the connecting plate 430 has two recessing parts 430a. The power lock 420 is able to move the gate structures 420a horizontally. When the gate structures 420a are located at a position as shown in FIG. 16, the gate structures 420a and the recessing parts 430a form two closed holes. When the power lock 420 moves the gate structures 420a horizontally and makes the gate structures 420a to leave the recessing part 430a, the holes are opened.

By the opening and closing of the holes structure, the power lock 420 is able to hold or release the swingable supporting plates 140. In particular, each of the swingable supporting plates 140 further includes a protruding part 140a. When the supporting surfaces 141 of the swingable supporting plates 140 face upwardly (as shown in FIG. 15), the protruding parts 140a are engaged in the closed holes formed by the gate structures 420a and the recessing parts 430a, and thus the swingable supporting plates 140 are hold in place for paper-sheets (not shown) to be stacked on them. When the gate structures 420a are moved away from the recessing parts 430a, the swingable supporting plates 140 are released and swing downwardly via gravity, and the stacked paper-sheets are correspondingly dropped.

A plurality of alternative embodiments of the power lock 420 is described in detail in U.S. patent application Ser. No. 15/826,368, which is incorporated herein by reference in its entirety.

As shown in FIG. 16, a connecting rod 440 is additionally introduced to enhance the stability of the swinging of the swingable supporting plates 140. The connecting rod 440 is geared between the swingable supporting plates 140, and the connecting rod 440 makes the two swingable supporting plates 140 to swing upwardly or downwardly simultaneously. For example, when one of the swingable supporting plates 140 swings downwardly, the other one would be driven to swing downwardly by the connecting rod 440 at the same time. The connecting rod 440 ensures the two swingable supporting plates 140 to swing in a symmetric manner, which effectively prevents the paper-sheets (not shown) from rolling over when falling.

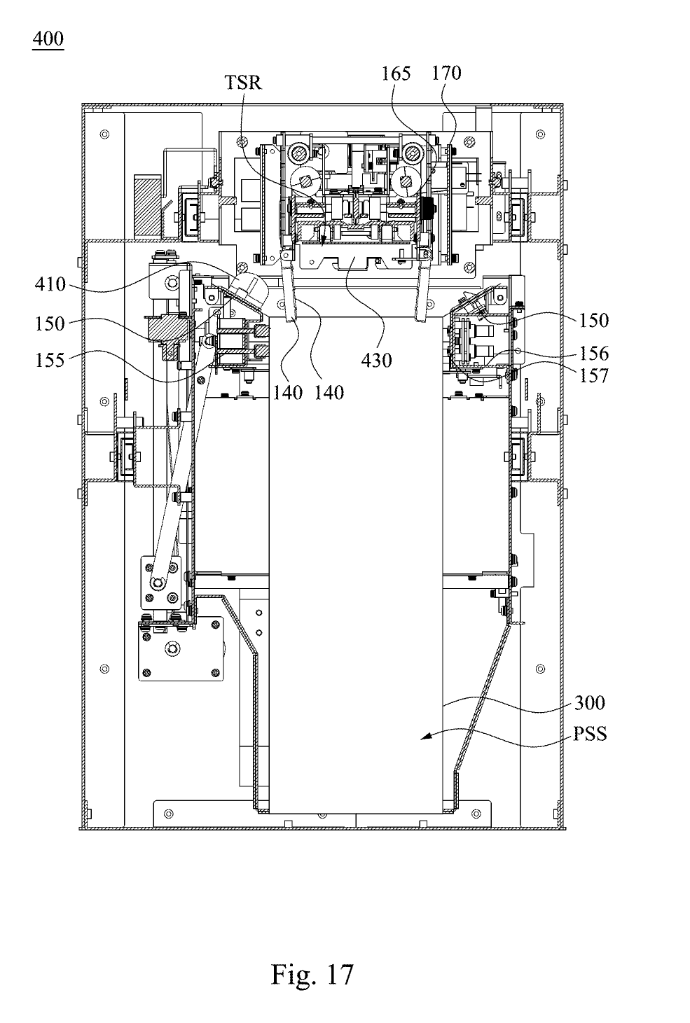

After the swingable supporting plates 140 are released by the power lock 420, the swingable supporting plates 140 are swung downwardly, this is shown in FIG. 17. FIG. 17 illustrates a cross-sectional view of the paper-sheet storage device 400 when the swingable supporting plates 140 are swung downwardly. At this state, a gap is formed between the two swingable supporting plates 140, and thus paper-sheets (not shown) may be dropped into the paper-sheet bag 300.

Next, the sealing mechanism 155 may seal the paper-sheet bag 300 (the sealing mechanism is similar to that of the paper-sheet storage device 100 and thus relevant description is skipped herein). When the abutting surfaces 157 of the sealing mechanism 155 approach towards each other in a horizontal direction, the bump 410 disposed above the abutting surface 157 moves together with the abutting surface 157.

As shown in FIG. 17, as the bump 410 moves horizontally to the right, the bump 410 would abut against one of the swingable supporting plates 140 at first, and then both of the swingable supporting plates 140 would be pushed upwardly (since the connecting rod 440 shown in FIG. 16 gears the two swingable supporting plates 140 together). In the present embodiment, there is a vertical distance between the bump 410 and the connecting plate 430, and thus the bump may not push the swingable supporting plates 140 completely back into the position as shown in FIG. 15 (that is, the position that both of the supporting surfaces 141 face upwardly and the swingable supporting plates 140 are fixed by the power lock 420). In this case, the extendible structure 170 may be controlled to extend downwardly and drive the swingable supporting plates 141 to move downwardly, as such the swingable supporting plates may be completely pushed back into the position as shown in FIG. 15. It should be understood that the mechanism of extendible structure 170 is similar to that of the paper-sheet storage device 100, and thus relevant description is skipped herein.

After the swingable supporting plates 140 are pushed back into the position shown in FIG. 15 (that is, the state that the supporting surfaces 141 face upwardly), then the power lock 420 (see FIG. 16) would hold the swingable supporting plates 140 in place. As such, the bump 410 successfully reset the swingable supporting plates 140, and the temporary storage region TSR above the swingable supporting plates 140 is cleared, more paper-sheets may be inserted into the paper-sheet storage device 400.

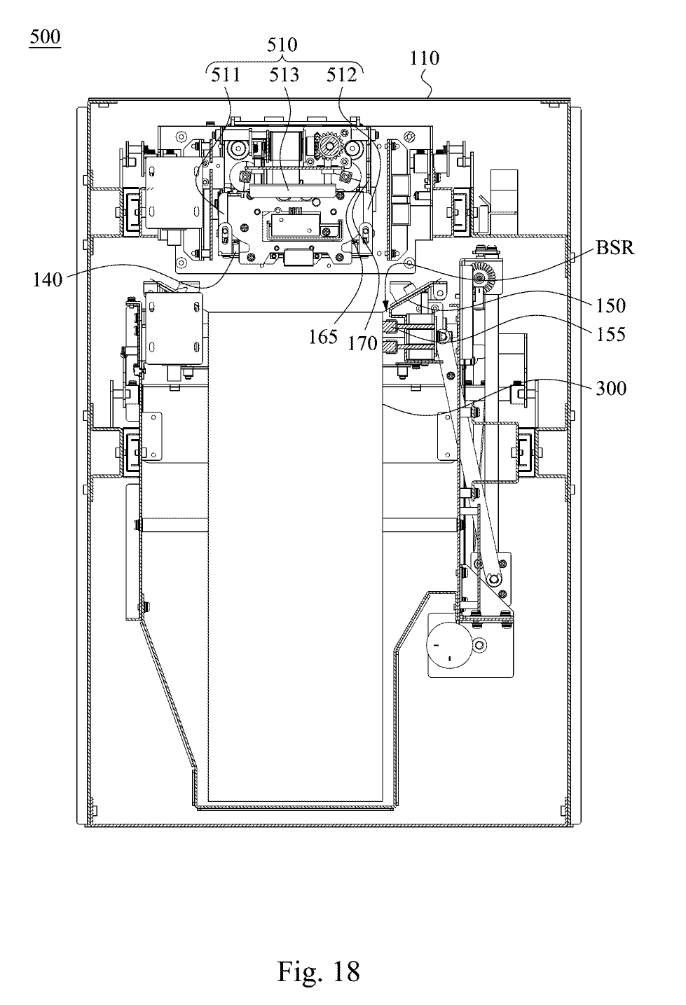

Please refer to FIG. 18, which illustrates a cross-sectional view of a paper-sheet storage device 500 according to yet another embodiment of the present disclosure. As shown in FIG. 18, the paper-sheet storage device 500 includes a housing 110, a paper-sheet bag disposing part 150, a pair of swingable supporting plates 140, a sealing mechanism 155, at least one first extendible structure 170, and a linkage mechanism 510. The paper-sheet bag disposing part 150 is disposed in the housing 110. The paper-sheet bag disposing part 150 is applicable to be removably installed with a paper-sheet bag 300. The paper-sheet bag disposing part 150 and the housing 110 define a paper-sheet bag storage region BSR. The swingable supporting plates 140 are disposed in the housing 110 and above a bottom portion of the paper-sheet bag storage region BSR. Each of the swingable supporting plates 140 has a supporting surface 141 (the supporting surfaces 141 are similar to the ones shown in FIG. 15, however are blocked in the present figure), and a temporary storage region TSR is defined by a space projected upwardly by the supporting surface 141 when the supporting surface 141 faces upwardly. The temporary storage region TSR is applicable to temporarily stack a plurality of paper-sheets received from an inlet 122 (please refer to FIG. 1). When the swingable supporting plates 140 swing downwardly, the paper-sheets fall from the temporary storage region TSR and then the paper-sheets are received by the paper-sheet bag 300. The sealing mechanism 155 is disposed below the paper-sheet bag disposing part 150, and the sealing mechanism 155 is configured to seal the paper-sheet bag 300. The linkage mechanism 510 is connected between the pair of the swingable supporting plates 140, such that the pair of the swingable supporting plates 140 swings downwardly or upwardly simultaneously.

As shown in FIG. 18, most of the elements are similar to those drawn in FIG. 15. However, the mechanism to reset the swingable supporting plates 140 in the paper-sheet storage device 500 is different from that in the paper-sheet storage device 400. In the present embodiment, the swingable supporting plates 140 are reset by the linkage mechanism 510 instead of the bump 410.

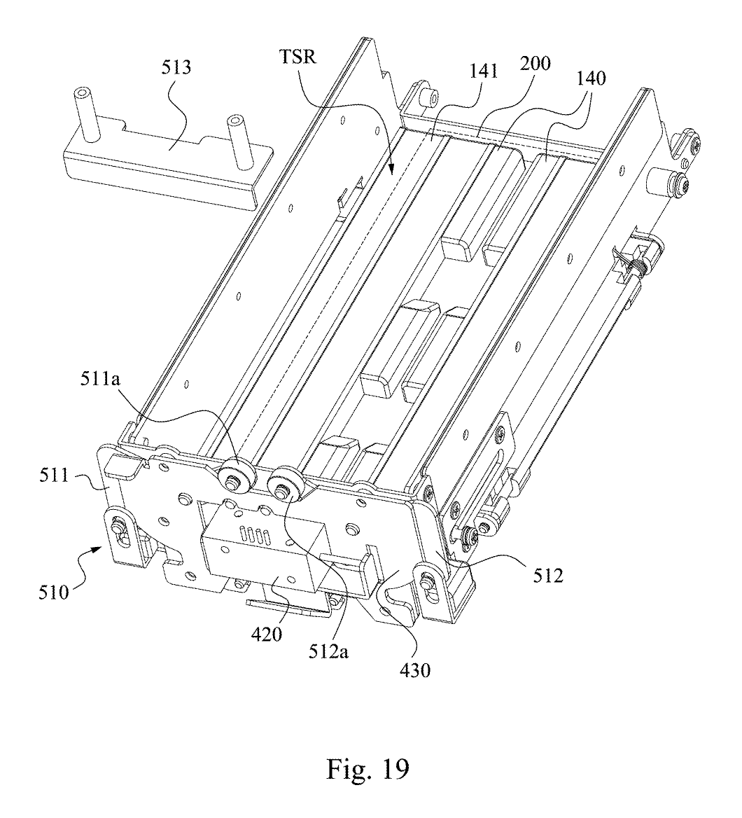

As shown in FIG. 18, the linkage mechanism 510 includes a first linkage 511, a second linkage 512, and a connecting member 513. An end of the first linkage 511 is linked to one of the swingable supporting plates 140, and the other end of the first linkage 511 is disposed with a first wheel 511a (shown in FIG. 19). Similarly, an end of the second linkage 512 is linked to the other one of the swingable supporting plates 140, and the other end of the second linkage 512 is disposed with a second wheel 512a (shown in FIG. 19). The connecting member 513 is fixed in the housing 110. When the paper-sheets storage device 500 is in the state shown in FIG. 18, the connecting member 513 connects to the first linkage 511 and the second linkage 512. When the first extendible structure 170 extends downwardly, the first linkage 511 and the second linkage 512 leave the connecting member 513. It should be understood that the mechanism of extendible structure 170 is similar to that of the paper-sheet storage device 100, and thus relevant description is skipped herein.

Please refer to FIG. 19, which illustrates a state that the first extendible structure 170 extends downwardly, such that the first linkage 511 and the second linkage 512 leave the connecting member 513. The relevant cross-sectional view of the paper-sheet storage device 500 at this state is similar to that drawn in FIG. 10, in which the paper-sheets 200 are stacked on the supporting plates.

As shown in FIG. 19, the paper-sheet storage device 500 also includes a power lock 420 and a connecting plate 430, which are the same as the ones employed in the paper-sheet storage device 400 as shown in FIG. 15, and thus relevant description is skipped herein. When the swingable supporting plates 140 are in a horizontal position that the supporting surfaces 141 faces upwardly, the power lock 420 locks the swingable supporting plates 140 in place for paper-sheets 200 to be stacked on them. When the swingable supporting plates 140 are released and fall downwardly, the paper-sheets 200 are correspondingly dropped, and the first linkage 511 and second linkage 512 are respectively rotated and make the first wheel 511a and second wheel 512a to move upwardly.

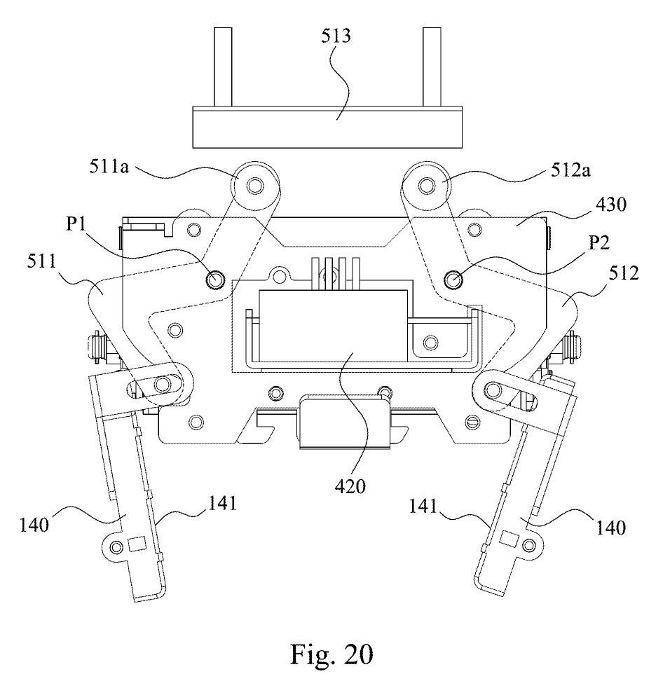

Please refer to FIG. 20, which illustrates a front view of the swingable supporting plates 140 and the linkage mechanism 510 when the swingable supporting plates 140 have been released by the power lock 420. At this state, the paper-sheets 200 leave the temporary storage region TSR and fall into the paper-sheet bag 300 shown in FIG. 18.

As shown in FIG. 20, the first linkage 411 and the second linkage 512 are rotatably fixed on the connecting plate 430. In particular, the first linkage 511 is able to rotate around a point P1, and the second linkage 512 is able to rotate around a point P2. In the present embodiment, the first linkage 511 and the second linkage 512 are designed to rotate in an opposite direction with respect to the swinging direction of the corresponding swingable supporting plate 140. For example, when the swingable supporting plates 140 connected to the first linkage 511 swings in a clockwise direction, the first linkage 511 is driven to rotate in a counterclockwise direction, and vice versa.

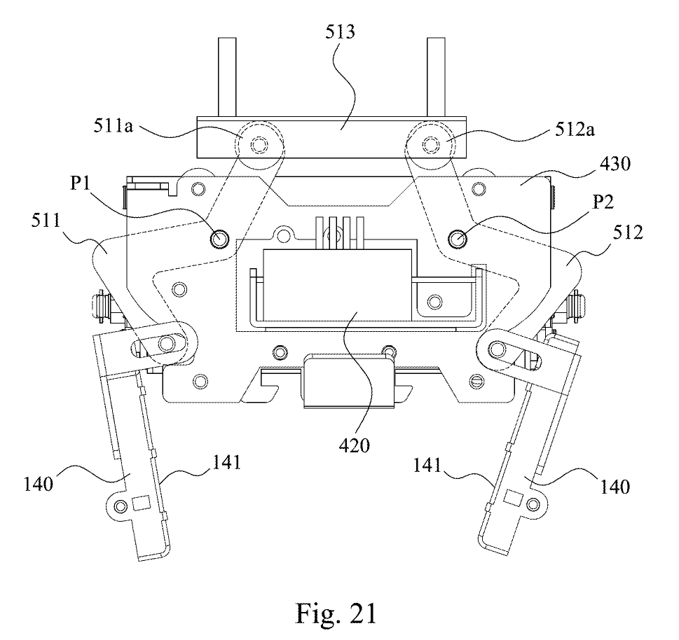

Please refer to FIG. 21, which illustrates a front view of the swingable supporting plates 140 and the linkage mechanism 510 in another state. After the paper-sheets 200 are cleared from the temporary storage region TSR, the first extendible structure 170 may be contracted upwardly, and the connecting member 513 is relatively moved towards the first linkage 511 and the second linkage 512. At the state shown in FIG. 21, the connecting member 513 abuts against the first linkage 511 and the second linkage 512.

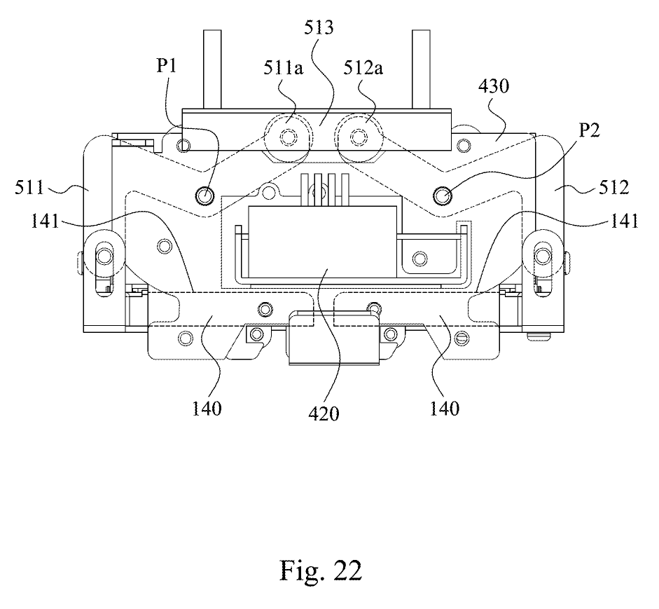

Please refer to FIG. 22, which illustrates a front view of the swingable supporting plates 140 and the linkage mechanism 510 in the state shown in FIG. 18. After the connecting member 513 abuts against the first linkage 511 and the second linkage 512, the connecting member 513 further pushes the first linkage 511 and the second linkage 512 to make them rotate. When the first linkage 511 and the second linkage 512 rotate, the swingable supporting plates 140 are driven to swing upwardly accordingly at the same time. As shown in FIG. 22, the swingable supporting plates 140 are completely pushed back to their original position shown in FIG. 18.

In other words, when the connecting member 513 is in a position shown in FIG. 22, the supporting surfaces 141 of swingable supporting plates 140 face upwardly, and when the connecting member 513 is in a position shown in FIG. 20 or FIG. 21, an opening is formed between the swingable supporting plates 140. Furthermore, by the extension and contraction of the first extendible structure 170, one may determine the relative position of the connecting member 513, and the motion of the swingable supporting plates 140 may be successfully controlled.

In other words, the swingable supporting plates 140 are swung downwardly from a state shown in FIG. 19 to a state shown in FIG. 20, and then the swingable supporting plates 140 are swung upwardly from the state shown in FIG. 20 to a state shown in FIG. 21, and then back into their original position shown in FIG. 22.

In sum, the technical solutions provided by the present disclosure have several advantages over the present ones. In other words, the aforementioned technical solutions improve the present technology, and may be generously applied in the industry, several advantages of the present disclosure are exemplified as follow:

(1) When the swingable supporting plates swing downwardly, the paper-sheets stacked in the temporary storage region lose the support of the supporting surface, and thus the paper-sheets fall into the paper-sheet bag. As such, by the swinging of the swingable supporting plate to make the swingable supporting plates form an opening therebetween and resulting in the paper-sheets fall into the paper-sheet bag, arbitrary number of the paper-sheets would be appropriate. Without limitation on the quantity of the paper-sheets, the paper-sheet storage device may operate with more efficiency.

(2) By the gradually extension of the first extendible structure, the height of the temporary storage region may be restricted in a certain range, and the restricted height of the temporary storage region may effectively prevent the paper-sheets from rolling over in an oversized temporary storage region, and thus making the paper-sheets to be stacked neatly.

(3) When the amount of the paper-sheets is gradually increased in the temporary storage region, such that the distance measured by the sensor is smaller than a first predetermined quantity, the second extension mechanism controller would activate the second power source so as to drive the first extendible structure to extend downwardly, so as to ensure the temporary storage region provides sufficient space for the paper-sheets to be stacked in.

(4) By the separation of the film structure, it is effectively prevented the paper-sheets located in the temporary storage region from stuck in the scissor-like extendible structures.

(5) The pressing wheel abuts against the paper-sheets and makes the paper-sheets at least partially deform towards the recessing portion. By the deformation of the paper-sheets, the rigidity of the paper-sheets along the vertical direction may be enhanced, which is beneficial for the paper-sheets to be stacked neatly in the temporary storage region.

(6) The connecting rod ensures the two swingable supporting plates to swing in a symmetric manner, which effectively prevents the paper-sheets from rolling over when falling.

(7) A user may control the motion of the swingable supporting plates by the linkage mechanism.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A paper-sheet storage device applicable to a paper-sheet bag machine type, the paper-sheet storage device comprising:
a housing;
a paper-sheet bag disposing part disposed in the housing, the paper-sheet bag disposing part is applicable to be removably installed with a paper-sheet bag, and the paper-sheet bag disposing part and the housing define a paper-sheet bag storage region;
at least one first extendible structure connected in the housing; at least one swingable supporting plate disposed in the housing and above a bottom portion of the paper-sheet bag storage region, and the swingable supporting plate has a supporting surface, a temporary storage region is defined by a space projected upwardly by the supporting surface when the supporting surface faces upwardly, and the temporary storage region is located between the first extendible structures, the temporary storage region is applicable to temporarily stack a plurality of paper-sheets received from an inlet, and when the swingable supporting plate swings downwardly, the paper-sheets fall from the temporary storage region and is received by the paper-sheet bag; and
a sealing mechanism disposed below the paper-sheet bag disposing part, the sealing mechanism is configured to seal the paper-sheet bag.

2. The paper-sheet storage device of claim 1, further comprising:
at least one first torsion spring connected to the first extendible structure and the swingable supporting plate, such that the swingable supporting plate is linked with the first extendible structure.

3. The paper-sheet storage device of claim 2, wherein there is a pair of the swingable supporting plates, a pair of the first extendible structures, and a pair of the first torsion springs, the swingable supporting plates are located between the first torsion springs, and the swingable supporting plates are separated by a gap, wherein when the swingable supporting plates are in a first state, the swingable supporting plates permit the paper-sheets to be stacked on the swingable supporting plates, and when the swingable supporting plates are in a second state, the swingable supporting plates swing downwardly to enlarge the gap, so as to permit the paper-sheets to fall into the paper-sheet bag.

4. The paper-sheet storage device of claim 3, further comprising:
a second extendible structure connected in the housing, and at least partially located between the first extendible structures, a bottom portion of the second extendible structure is above the swingable supporting plates.

5. The paper-sheet storage device of claim 4, further comprising:
an lower conveying channel connected to the housing, the lower conveying channel has a first end opening and a second end opening opposing to the first end opening, the second end opening is located correspondingly to the temporary storage region, the lower conveying channel is configured to convey the paper-sheets from the first end opening through the second end opening to the temporary storage region;
a first power source, mechanically connected to the second extendible structure; and
a first extension mechanism controller electrically connected to the lower conveying channel and the first power source, when the lower conveying channel conveys a predetermined quantity of paper-sheets to the temporary storage region, the first extension mechanism controller activates the first power source, so as to drive the second extendible structure to extend towards the temporary storage region.

6. The paper-sheet storage device of claim 5, further comprising:
a second power source mechanically connected to the first extendible structure; and
a second extension mechanism controller electrically connected to the second power source and the first extension mechanism controller, when the second extendible structure abuts against the paper-sheets temporarily stacked in the temporary storage region, the second extension mechanism controller activates the second power source, so as to drive the first extendible structure to pull back upwardly, so as to make the swingable supporting plate swing downwardly.

7. The paper-sheet storage device of claim 5, wherein the lower conveying channel further comprising:
a main body having a guiding plate, the guiding plate has a recessing portion;
a rotating shaft pivoting with the main body, the second end opening is located between the rotating shaft and the guiding plate; and
a pressing wheel disposed at the rotating shaft, an outside diameter of the pressing wheel is greater than an outer diameter of rotating shaft, and the pressing wheel is located correspondingly to the recessing portion,
wherein the lower conveying channel permits each of the paper-sheets to be sent out from the second end opening along a vertical direction corresponding to each of the paper-sheet, and the pressing wheel abuts against each of the paper-sheets and make each of the paper-sheets at least partially deform towards the recessing portion.

8. The paper-sheet storage device of claim 5, wherein the paper-sheet bag disposing part comprises at least a pair of installing surfaces configured to install the paper-sheet bag, the sealing mechanism comprises a pair of abutting parts, a paper-sheet bag disposing region is defined between the abutting parts, the paper-sheet bag is at least partially located in the paper-sheet bag disposing region, each of the abutting parts have an abutting surface, the abutting surfaces face towards each other and are able to approach towards or move away from each other, and are respectively adjacent to a corresponding one of the installing surfaces, the installing surfaces slant opposing towards the corresponding one of the abutting parts, the paper-sheet storage device further comprises a sealing controller electrically connected to the sealing mechanism, and is configured to activate the sealing mechanism to make the abutting surfaces move towards each other.

9. The paper-sheet storage device of claim 8, further comprising:
a second power source mechanically connected to the first extendible structure;
a second extension mechanism controller electrically connected to the second power source; and
a sensor disposed below the second extendible structure, the sensor is configured to measure a distance between itself and the paper-sheets located in the temporary storage region, and the sensor is electrically connected to the second extension mechanism controller and the sealing controller, when the distance measured by the sensor is smaller than a first predetermined quantity, the second extension mechanism controller activates the second power source to drive the first extendible structure extend downwardly, when the distance measured by the sensor is greater than a second predetermined quantity, the sealing controller activated the sealing mechanism, so as to make the abutting surfaces move towards each other.

10. The paper-sheet storage device of claim 5, further comprising an upper module, which comprises:
a casing having an inlet, an outlet, and a conveying port, the inlet is configured to permit the paper-sheets to enter the casing in order, the outlet and the conveying port are configured to permit the paper-sheets to leave the casing in order, the conveying port is corresponded to the first end opening of the lower conveying channel; and
a discrimination unit disposed in the casing, the discrimination unit is configured to discriminate at least one feature of the paper-sheets, the paper-sheets un-allowed by the discrimination unit is conveyed to the outlet, and the paper-sheets allowed by the discrimination unit is conveyed to the conveying port.

11. The paper-sheet storage device of claim 2, wherein the first extendible structure is a scissor-like extendible structure, the paper-sheet storage device further comprises a film structure, an end of the film structure is connected to the housing, the other end of the film structure is connected to a bottom end of the scissor-like extendible structure, the film structure is at least partially located between the scissor-like extendible structure and the temporary storage region.

12. The paper-sheet storage device of claim 11, further comprising:
a rolling shaft pivoting with the housing, the film structure is connected to the rolling shaft; and
at least one second torsion spring connected to the rolling shaft and the housing.

13. The paper-sheet storage device of claim 11, further comprising:
a rolling shaft pivoting to the housing, the film structure is connected to the rolling shaft;
a third power source; and
a gear set mechanically connected to the rolling shaft and the third power source, the third power source provides power so as to drive the rolling shaft to rotate via the gear set.

14. The paper-sheet storage device of claim 1, wherein the sealing mechanism comprises a pair of abutting parts, each of the abutting parts has an abutting surface, and the abutting surfaces face towards each other and are able to approach towards or move away from each other; and the paper-sheet storage device further comprising:
a bump disposed above one of the abutting surfaces, wherein when the swingable supporting plate is swung downwardly and the abutting surfaces approach towards each other, the bump abuts against the swingable supporting plate and pushes the swingable supporting plate to swing upwardly.

15. The paper-sheet storage device of claim 14, wherein there is a pair of the at least one swingable supporting plate, and the paper-sheet storage device further comprises:
a connecting rod gearing between the pair of the swingable supporting plates, such that the pair of the swingable supporting plates swing downwardly or upwardly simultaneously.

16. The paper-sheet storage device of claim 14, further comprising:
a power lock connected to the swingable supporting plate, wherein when the supporting surface faces upwardly, the power lock is configured to lock the swingable supporting plate in place or to release the swingable supporting plate and let the swingable supporting plate swing downwardly.

17. The paper-sheet storage device of claim 1, further comprising:
a linkage mechanism connected between the pair of the swingable supporting plates, such that the pair of the swingable supporting plates swing downwardly or upwardly simultaneously.

18. The paper-sheet storage device of claim 17, wherein the linkage mechanism further comprises:
a first linkage linked to one of swingable supporting plates;
a second linkage linked to the other one of the swingable supporting plates; and
a connecting member connected with the first linkage and the second linkage, wherein when the connecting member is located in a first position, the pair of the swingable supporting plates facing upwardly, and when the connecting member is located in a second position, an opening is formed between the pair of the swingable supporting plates.

19. The paper-sheet storage device of claim 18, wherein the linkage mechanism further comprises:
a first wheel connected between the first linkage and the connecting member; and
a second wheel connected between the second linkage and the connecting member.

20. A paper-sheet storage device applicable to a paper-sheet bag machine type, the paper-sheet storage device comprising:
a housing;
an inlet disposed outside of the housing;
an extendible structure connected in the housing, the extendible structure is extensible along a height direction of the housing;
a paper-sheet bag, the paper-sheet bag defines a paper-sheet storage space, and the paper-sheet bag has a paper-sheet bag opening facing upwardly;
at least one paper-sheet supporting plate disposed in the housing and above a bottom portion of the paper-sheet storage space, the paper-sheet supporting plate is able to move with the extension of the extendible structure, the paper-sheet supporting plate has a supporting surface;
a sensor disposed above the paper-sheet supporting plate, the sensor is configured to measure a distance between the sensor and a plurality of paper-sheets stacked on the paper-sheet supporting plates;
an extension mechanism controller electrically connected to the sensor and the extendible structure, the extension mechanism controller is configured to control the extension and contraction of the extendible structure according to the distance measure by the sensor; and
a sealing mechanism disposed in the housing and adjacent to the paper-sheet bag opening, the sealing mechanism is configured to seal the paper-sheet bag;
wherein when the paper-sheet supporting plate is in a first state, a temporary storage region is defined by a space projected upwardly by the supporting surface, the temporary storage region is applicable to temporarily stack the paper-sheets received from the inlet, when the paper-sheet supporting plate is in a second state, the paper-sheet supporting plate form an opening therebetween to let the paper-sheets fall from the opening and passing through the paper-sheet bag opening and fall into the paper-sheet bag;
wherein when the distance measured by the sensor is smaller than a first predetermined quantity, the extendible structure extends downwardly, and when the distance measured by the sensor is greater than a second predetermined quantity, the sealing mechanism seal the paper-sheet bag, the second predetermined quantity is greater than the first predetermined quantity.

21. The paper-sheet storage device of claim 20, wherein the sealing mechanism comprises a pair of abutting parts, a paper-sheet bag disposing region is defined between the abutting parts, the paper-sheet bag is at least partially located in the paper-sheet bag disposing region, each of the abutting parts have an abutting surface, the abutting surfaces face towards each other and are able to approach towards or move away from each other, the paper-sheet storage device further includes a sealing controller electrically connected to the sealing mechanism, when the distance measured by the sensor is greater than the second predetermined quantity, the sealing controller activates the sealing mechanism to make the abutting surfaces move towards each other.

22. The paper-sheet storage device of claim 20, wherein the extendible structure is a scissor-like extendible structure, the paper-sheet storage device further comprises a film structure, an end of the film structure is connected to the housing, the other end of the film structure is connected to a bottom end of the scissor-like extendible structure, the scissor-like extendible structure is more distal to the paper-sheets on the paper-sheet supporting plate than the film structure.

23. The paper-sheet storage device of claim 22, further comprising:
a rolling shaft pivoting to the housing, the film structure is connected to the rolling shaft; and
a torsion spring connected to the rolling shaft and the housing.

24. The paper-sheet storage device of claim 22, further comprising:
a rolling shaft pivoting with the housing, the film structure is connected to the rolling shaft;
a power source; and
a gear set mechanically connected to the rolling shaft and the power source, the power source provides power so as to drive the rolling shaft to rotate via the gear set.

25. A paper-sheet storage device applicable to a paper-sheet bag machine type, the paper-sheet storage device comprising:
a cabinet;
an inlet disposed outside of the cabinet;
at least one scissor-like extendible structure connected in the cabinet, the scissor-like extendible structure is extendible along a height direction of the cabinet;
a paper-sheet bag disposed in the cabinet, and the paper-sheet bag defines a paper-sheet storage space, and has a paper-sheet bag opening facing upwardly, the paper-sheet bag opening is applicable to receive a plurality of paper-sheets conveyed from the inlet;
at least one paper-sheet supporting plate disposed in the cabinet and above a bottom portion of the paper-sheet storage space, and the paper-sheet supporting plate is connected to the scissor-like extendible structure and is able to move with the extension of the scissor-like extendible structure, an end of the paper-sheet supporting plate most distal to the scissor-like extendible structure is defined as a distal end;
a film structure, an end of the film structure is connected to the cabinet, the other end is connected to a bottom end of the scissor-like extendible structure, the film structure is closer to the scissor-like extendible structure than the distal end of the paper-sheet supporting plate; and
a sealing mechanism disposed in the cabinet and adjacent to the paper-sheet bag opening, the sealing mechanism is configured to seal the paper-sheet bag;
wherein when the paper-sheet supporting plate is in a first state, a temporary storage region is defined by a space projected upwardly by a supporting surface of the paper-sheet supporting plate, the temporary storage region is applicable to temporarily stack the paper-sheets received by the inlet, when the paper-sheet supporting plate is in a second state, the paper-sheet supporting plate to form an opening therebetween to let the paper-sheets fall from the opening and pass through the paper-sheet bag opening and fall into the paper-sheet bag.

26. The paper-sheet storage device of claim 25, further comprising:
a rolling shaft pivoting to the cabinet, the film structure is connected to the rolling shaft; and
a torsion spring connected to the rolling shaft and the cabinet.

27. The paper-sheet storage device of claim 25, further comprising:
a rolling shaft pivoting to the cabinet, the film structure is connected to the rolling shaft;
a power source; and
a gear set mechanically connected to the rolling shaft and the power source, the power source provides power so as to drive the rolling shaft to rotate via the gear set.

28. The paper-sheet storage device of claim 25, further comprising:
an extendible structure connected in the cabinet, the extendible structure is extendible along a height direction of the cabinet, and a bottom of the extendible structure is above the paper-sheet supporting plate.
